(19) United States
(12) Patent Application Publication
(10) Pub. No.: US 2012/0143657 A1
(43) Pub. Date: Jun. 7, 2012

(54) PARKING SYSTEM AND METHOD

(75) Inventor: Michael Eli Silberberg, South Melbourne (AU)

(73) Assignee: CDS WORLDWIDE PTY LTD, South Melbourne (AU)

(21) Appl. No.: 13/310,526

(22) Filed: Dec. 2, 2011

(30) Foreign Application Priority Data
Dec. 3, 2010 (AU) 2010905328
Dec. 24, 2010 (AU) 2010905677
Aug. 31, 2011 (AU) 2011903513

(51) Int. Cl. G08G 1/14; G07B 15/02; G06Q 30/02

(52) U.S. Cl. 705/14.1; 705/32; 340/932.2

(57) ABSTRACT

A parking system comprising a plurality of parking apparatuses associated with respective ones of a plurality of parking bays, each parking apparatus comprising an electronic display, and a sensor having a sensor output indicative of whether a vehicle is parked in the parking bay, and a parking controller in data communication with each sensor and each display, the parking controller arranged to receive a parking request that enables the parking controller to identify a parking bay, process the parking request to determine whether to initiate a parking session in respect of the parking bay, and control the display associated with the parking bay to indicate that a parking session has been initiated upon initiation of a parking session.

### FIELD OF THE INVENTION

This invention relates to a parking system, a parking controller, a parking kit and method of providing parking for vehicles.

### BACKGROUND OF THE INVENTION

Conventional parking systems used in cities are generally provided in the form of multi-story car parks having a number of bays and some form of gated entrance. In some implementations the user pays upon entry (typically a flat fee) and the exit is unguarded. In other embodiments, the user pays shortly before they leave. In such embodiments, a user often obtains a ticket as they enter and makes payment a pay station in order to obtain a validated ticket which can then be used to cause a gate at the exit to allow the user to depart.

It would be useful to provide an alternative parking system.

### SUMMARY OF THE INVENTION

The invention provides a parking system comprising:
a plurality of parking apparatuses associated with respective ones of a plurality of parking bays, each parking apparatus comprising:
   an electronic display, and
   a sensor having a sensor output indicative of whether a vehicle is parked in the parking bay; and
a parking controller in data communication with each sensor and each display, the parking controller arranged to:
   receive a parking request enables the parking controller to identify a parking bay;
   process the parking request in conjunction with the sensor output for the parking bay to determine whether to initiate a parking session in respect of the parking bay; and
   control the display associated with the parking bay to indicate that a parking session has been initiated upon initiation of a parking session.

In an embodiment, the parking controller is arranged to receive the parking request from a mobile device over a telecommunications network.

In an embodiment, the parking controller is arranged to receive the parking request from a device carried by the vehicle.

In an embodiment the parking controller is further arranged to communicate the initiation of the parking session to a mobile device associated with a user or the vehicle when a parking session is initiated.

In an embodiment the parking controller is further arranged to charge a fee for the parking session to a user account associated with the mobile device.

In an embodiment the parking controller is arranged to determine the length of stay in the parking bay based on the sensor output and determine a fee amount from the length of stay.

In an embodiment the parking controller is arranged to determine whether to initiate a parking session by determining whether the parking request correlates to the sensor output.

In an embodiment the parking request comprises a bay identifier displayed at the parking bay and the parking controller determines whether the bay identifier correlates to the sensor output.

In an embodiment the sensor comprises an image capture device for capturing an image of the vehicle.

In an embodiment each parking apparatus further comprises an image capture device for capturing an image of the vehicle.

The parking system comprises a license plate recognition controller arranged to process the capture image to determine a captured license plate number of the vehicle.

In an embodiment the parking request enables the parking controller to identify a license plate associated with the request and the parking controller is arranged to determine whether to initiate a parking session by determining whether the license plate associated with the parking request correlates to the captured license plate number.

In an embodiment, the parking system comprises a user registration system adapted to enable a user to register with the parking system and establish a user account in the parking system to enable the user to be identified and charged, and wherein the parking controller is arranged to determine whether the user is registered in the parking system prior to initiating a parking session.

In an embodiment, the parking controller is arranged to communicate an expiry warning to a mobile device of a user associated with the vehicle prior to expiry of the parking session.

In an embodiment, the electronic display is arranged to display data specific to the user or the vehicle.

In an embodiment, the parking controller is arranged to communicate enforcement data to a mobile device of an enforcement officer to enable enforcement of parking conditions in respect of terminated parking sessions.

In an embodiment, the electronic display is arranged to display a license plate number corresponding to the parking session.

In an embodiment, the electronic display is arranged to indicate whether a valid parking session is in progress.

In an embodiment, each parking apparatus comprises a radio frequency module to enable the parking apparatus to communicate with the parking controller over an at least partially wireless communication link.

In an embodiment, communication of the initiation of the parking session to a mobile device includes communication of a coupon redeemable by the user for a discounted or complementary good or service.

The invention also provides a parking system kit comprising:
a plurality of parking apparatuses adapted to be associated with respective ones of a plurality of parking bays, each parking apparatus comprising:
   an electronic display, and
   a sensor having a sensor output indicative of whether a vehicle is parked in the parking bay; and
a parking controller adapted to be placed in data communication with each sensor and each display, the parking controller arranged to:
   receive a parking request that enables the parking controller to identify a parking bay;
   process the parking request in conjunction with the sensor output for the parking bay to determine whether to initiate a parking session in respect of the parking bay; and
   control the display associated with the parking bay to indicate that a parking session has been initiated upon initiation of a parking session.

The invention also provides a method of parking comprising:
receiving an electronic parking request that identifies a parking bay;
processing the parking request in conjunction with a sensor output associated with the identified parking bay to determine whether to initiate a parking session in respect of the parking bay; and
controlling an electronic display associated with the parking bay to indicate that a parking session has been initiated upon initiation of a parking session.

The invention also provides a parking controller arranged to:
receive an electronic parking that identifies a parking bay;
process the parking request in conjunction with a sensor output associated with the identified parking bay to determine whether to initiate a parking session in respect of the parking bay; and
control an electronic display associated with the parking bay to indicate that a parking session has been initiated upon initiation of a parking session.

The invention also provides a parking apparatus adapted to be associated with a parking bay, the parking apparatus comprising:
an electronic display; and
a sensor having a sensor output indicative of whether a vehicle is parked in the parking bay,
   the parking apparatus arranged to communicate with a parking controller to indicate that a vehicle has entered the parking bay, receive a communication from the parking controller indicating that a parking session has been initiated and control the display to indicate that the parking session has been initiated.

### BRIEF DESCRIPTION OF THE DRAWINGS

Exemplary embodiments of the invention will be described, by way of example, with reference to the accompanying drawings, in which:

FIG. 1 shows a parking system of a first embodiment;

FIG. 2 shows detail of a parking controller of FIG. 1;

FIG. 3 is a schematic diagram of a parking apparatus installation;

FIG. 4 is a block diagram of a parking apparatus; and

FIG. 5 is a block diagram of an alternate parking system.

### DETAILED DESCRIPTION

The Figures show a parking system 100, 500 for a car park. The parking system allows a user initiate payment for parking with a mobile communications device, or with a dedicated device carried by the user's vehicle. All mobile communication devices include some form of radio frequency module to enable communication over a wireless communication network. Depending on the implementation, the wireless network may be a short distance, local area network or a wide area network such as typically is provided by telecommunications infrastructure. Accordingly, the mobile communications devices which are compatible with the parking system will depend on the specific implementation.

Examples mobile communication techniques which may be employed in various embodiments of the invention are connecting to a computer server over an at least partially wireless network and sending messages via the short messaging service (SMS) protocol. Persons skilled in the art will appreciate that other communication techniques can be used depending on the implementation.

In the embodiments, the user pre-registers with the system so they can use it upon arrival at a car park. To this end, the parking system 100 has a web server 60 which hosts a user registration system 62 such as are known in the art. The user registration system is used to allocate the unique identifier to each user as well as to capture other important information such as the user's billing details and to establish some form of access control, for example, a password. Such data is captured in a conventional manner (e.g. by filling out an electronic form) and stored in user database 63.

Accordingly, when the user enters the car park, they can use their pre-established identifier and password in order to pay for parking.

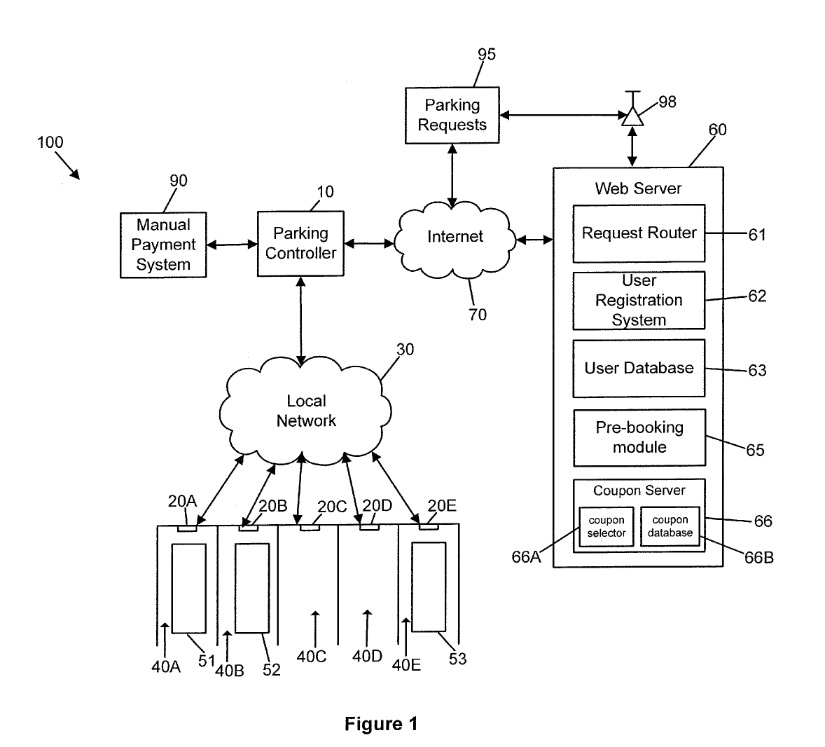

FIG. 1 shows schematically an arrangement which may confront a typical user on arrival at a car park. There are five parking bays 40A, 40B, 40C, 40D and 40E. Three of these bays 40 are occupied by vehicles 51, 52 and 53 leaving parking bays 40C and 40D empty. Each of the parking bays 40 is associated with a parking apparatus in the form of a parking unit 20. The parking unit 20 includes an electronic display 21. As the bays 40C, 40D are unoccupied the display 21 is controlled to output a green colour (or other suitable information) indicating that the parking bay is available to assist a user to locate the parking spot.

When the user enters the parking spot 40C a camera 22 of the parking unit 20 determines that the user has entered the bay 40C and captures an image of the vehicle. In one embodiment, this is achieved by the camera 22 capturing images at pre-determined time intervals under control of microcontroller 21. In this respect, it will be appreciated that the camera can function as a sensor indicative of whether the bay 40C is occupied. Alternatively, an additional sensor such as an infrared or ultrasonic sensor may be used to determine that the vehicle has entered the car parking bay 40C in order to trigger the camera 22. The microcontroller 21 of the parking unit 20 sends the captured camera image using radio frequency (RF) module 24. The RF module may employ any suitable form of wireless communication such as WI-FI or GPRS to the parking controller 10. While a wireless installation advantageously reduces the wiring requirements of the installation, a wired connection such as an Ethernet, may be employed in other embodiments.

Communication from the parking unit is received by a parking unit interface 11 of the parking controller 10 and passed to a parking request correlator 12. The parking request correlator 12 incorporates a license plate recognition system 12A which processes the captured image in order to extract the license plate number.

In parallel, a user initiates a parking request. In this respect, during the registration process, the user is either provided with a web server address, downloads a specific application onto their mobile device which will automatically connect them to the web server or is advised that they will need to send SMS messages to pay for parking.

Accordingly, it will be appreciated that as illustrated in FIG. 1 a parking request 95 initiated by a user may either be received by the web server 60 over the internet 70 or in the case of an SMS message via a telecommunications infrastructure 98 which is arranged to route messages to the web server 60 for processing.

In order to make the parking request 95, the user enters their unique identifier and password as well as data that identifies the bay 40C in which they have parked. To this end, a sign 80 is placed under the parking unit 20 which displays a bay identification number 81 and a car park identifier 82. In other embodiments, it will be appreciated that a single identifier may incorporate both the car park identification and the bay identification or it may not be necessary to identify the car park. For example, the car park may have a designated address/number.

The web server 60 receives the parking request and routes the request 61 to the relevant parking controller 10 based on the identifier (Bearing in mind that there may be many parking controllers in the system for separate car parks). During the routing process, the parking request may have added to it any user information which needs to be extracted from the database. In one embodiment, the parking request includes the user's mobile phone number and the user's phone number is used to extract the user's license plate registration from the user database 63. In other embodiments, the user may manually enter the license plate number.

The parking request is received from the web server by the web server interface 13 and provided to the parking request correlator 12 which attempts to correlate the parking request with the information received from the parking unit 20. In the embodiment it does this by checking that the bay identifier in the parking request corresponds to a signal received from the sensor and that the license plate in the request matches the recognised license plate.

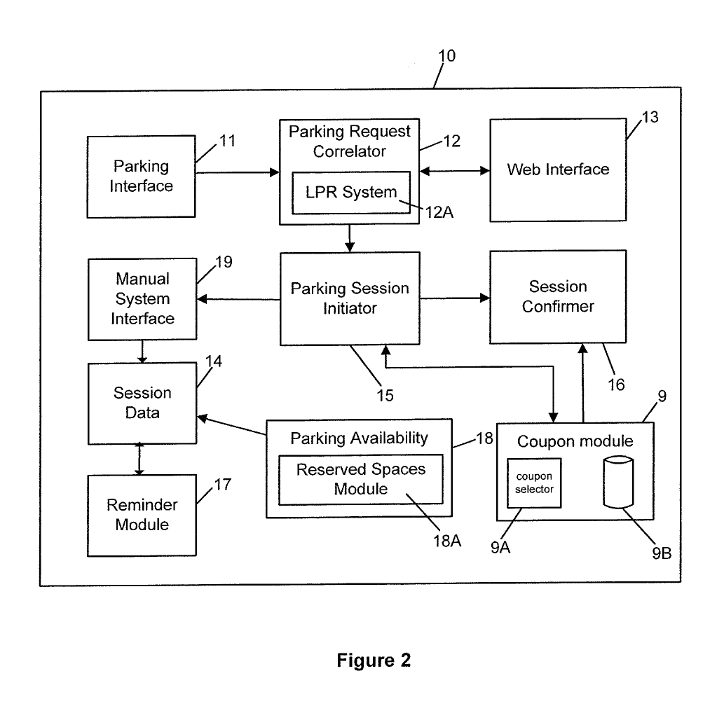

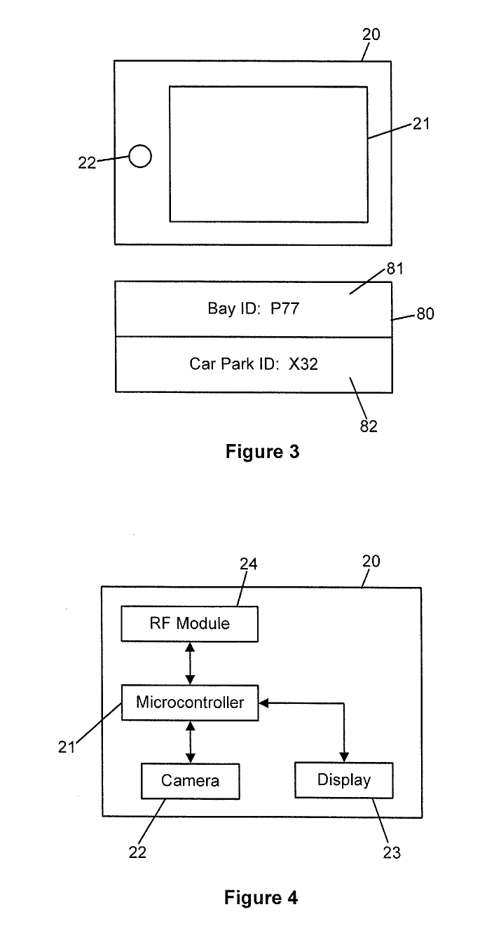

If the relevant data matches, the parking session initiator 15 initiates a parking session by establishing a user specific session in session data 14 which specifies the start time of the parking session and identifies the user. The parking controller 10 also includes a session confirmer 16 which sends a message to the user's mobile phone via internet 70 to web server 60 and ultimately via telecommunications infrastructure 98 confirming that the parking session has started. Alternatively, the web server 60 may serve a page confirming that the parking session has been initiated over the internet 70 to a web enabled mobile device. As indicated in FIG. 2, additional information may be communicated to the user as part of establishment of the session. In the embodiment of FIG. 2, this information takes the form of one or more coupons being communicated to the user. To this end, when parking initiator determines that a parking session is to start, if a coupon is to be delivered, parking session imitator activates a coupon module 9

that provides a coupon to session confirmer to send to the user with the session confirmation message.

Coupon module 9 has a coupon selector 9A that determines one or more coupons to send from coupon database 9B based on encoded selection rules. For example, coupons may be selected on a time basis such that a coffee coupon is delivered in the morning and a beer coupon is delivered in the evening. The coupon typically identifies a discount or complementary product that the user can redeem by showing the coupon to the relevant business. The coupon can be delivered in the message confirming the parking session or in a separate message. At some time points only one coupon may be available such that a selection process is not necessary.

Instead of sending a coupon directly, session confirmer 16 can be controlled send a link to a website where a coupon can be retrieved. Such a coupon server 66 may be hosted by web server 60. For example, a user may be able to select a limited or unlimited number of coupons. The link to the website may be arranged such that the coupons displayed when the link is followed are relevant to the car park at which the user has parked.

Accordingly, it will be appreciated that this embodiment allows business to target customers with geographically and time relevant coupons.

FIG. 2 illustrates that a coupon selector 66A can be located at the web server 60 instead of at the parking controller. Coupon server 66 includes a coupon selector 66A arranged to select coupons from a coupon database by interrogating the user database. In this embodiment, when request router 61 receives a request to send a parking confirmation message to the user, it activates the coupon server such that a coupon is selected. In such embodiments, coupon selector may access data from user database to aid the selection. For example, as part of the registration process, the user may input information such as their interest which aid selection of a coupon. Other information captured about the user such as previously redeemed coupons, personal information such as age or gender, and/or the type of car they drive may be used to as part of the encoded rules for selecting coupons to send to the user (or make available at a web link).

Once the user has initiated a parking session, the parking session initiator 15 communicates with display 21 to change what is displayed on the display to indicate that a parking session is in progress. This can, in some embodiments, take the form of turning the display from green to red. In other embodiments, the user's number plate may be displayed so as to make it clear that there is a one to one correspondence between the user and the parking spot.

In one embodiment, there is no limit on the time that the user may park for so that when the user leaves the car parking bay this is noted by the camera 22 of the parking unit 20, the session is ended, and the user is charged accordingly. In other embodiments, the user may need to pre-specify the amount of time they wish to park for as part of the parking request and may be charged at that time.

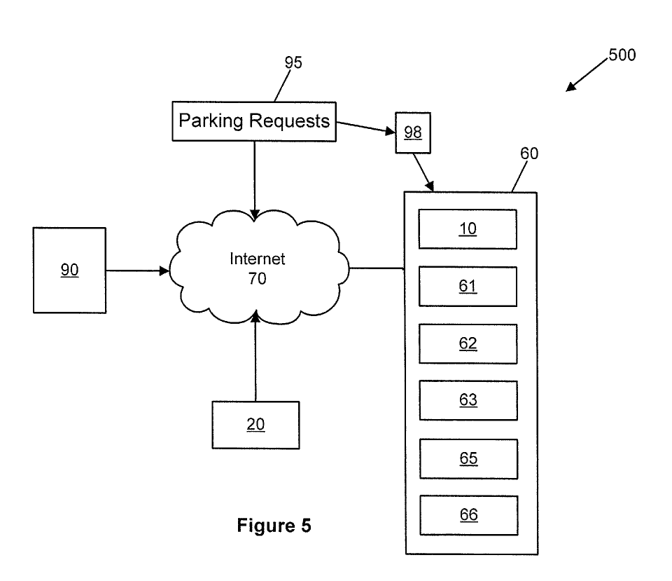

FIG. 5 shows an alternative embodiment where the parking controller is co-located with the web server 60. In this embodiment, all communications from the parking units 20 are over the internet 70. Otherwise, the numbered components perform the same functions described elsewhere.

The systems of FIGS. 1 and 5 are shown as incorporating some additional features. In particular, the parking controller 10 includes a reminder module 17 for sending reminders to the user based on session data at a defined time interval prior to the relevant parking session expiring. Further, the parking system has a manual payment system 90 interfaced to the parking controller via manual system interface 19 which enables other users to pay for parking. In one embodiment, the manual payment system is in the form of a kiosk having an a key pad, a display and one or more mechanisms for receiving payment such as a currency acceptor, a coin slot, and a credit card reader. In one embodiment, the user enters the bay number where they parked, pays for parking (e.g. at a flat rate) and is issued a ticket to feed to a machine when they leave. In another embodiment, the user also enters their registration number for verification purposes. In each case, when the user pays, the display above the car parking bay is updated to indicate that a successful parking session is in progress. As above, in some embodiments, the display can be made specific to the user by using their vehicle registration number.

In other embodiments, the kiosk may be used by users who have pre-registered with the system as described above. In such embodiments, a user enters their bay and registration number (optionally together with a unique user identifier such as a password) after they park. In such an embodiment, the kiosk sends the parking request to the parking controller. A parking session is then initiated and charged to the user's pre-registered credit card in the manner described above. An SMS message is sent to the user's phone confirming that the parking session has started. When the user, leaves the car parking space, this is noted by the sensor. The user drives to the exit where their license plate is captured by a license plate recognition system connected to the parking controller. The parking controller determines that the license plate matches a paid for parking session and causes a boom gate at the exit to lift and allow the vehicle to exit. A further SMS message is sent to the user's phone confirming the amount paid.

Such embodiments are useful to cover situations where a user's mobile device is not working (e.g. a flat battery) or there is inadequate mobile phone reception. Such embodiments can also be used to provide many of the benefits of the invention in scenarios where mobile device payment is not desired as part of the installation or is not being used in an initial installation. In some embodiments, the kiosk may be operable to allow a user to establish a user account.

The parking controller also has a parking availability module 18 which is arranged to provide directions to users as to where available parking bays are located within the car park.

In some embodiments, the web server 60 may include a pre-booking module 65 enabling a user to reserve a car parking space before they arrive at a car park. In this embodiment, the user accesses the web server and enters the details of the car park and the time at which they want to arrive. The parking controller 10 determines a car parking spot which is currently available and reserves that spot for the user within defined parameters. A parking availability module 18 determines which parking bays are available and has a reserved spaces module 18A which allocates a space to the user and communicates this to the user via web server 60. The display 21 is then updated to indicate that the parking spot is reserved and, in some embodiments to indicate the vehicle for which it is reserved by means of its license plate.

When the user enters the car park, they navigate to the spot and park their car. The camera 22 captures a picture of the license plate in order to confirm that the correct user has parked in the car parking spot.

Other embodiments and additional features will be apparent to the person skilled in the art. For example, the parking controller 10 may also maintain data relating to the parking bay which relates to the amount of time a vehicle can be parked in the parking bay and any other prescribed parking conditions, such as whether no parking is available in a parking bay at a particular time.

In one embodiment, if the vehicle parks and no payment is made by the user, the parking controller 10 determines from the camera 22 that that parking is not being paid for and an appropriate message indicating that the vehicle is illegally parked can be forwarded to the enforcement officer. The enforcement officer can then issue a parking ticket to the vehicle. Similarly, if the vehicle overstays the parking time within the parking bay, a message can be sent to the enforcement officer so that a parking ticket can also be issued. In another embodiment, web server 60 may maintain a page or pages accessible by the enforcement officer over network 70 which enables the enforcement officer to view which parking bays are currently paid for by accessing the relevant page of web server. For example, the page may present a map of the bays of an area with any unpaid for bays highlighted. In this respect, display 22 may be controlled to show that an invalid parking session is in progress, e.g. by causing it to flash.

In some embodiments, the parking controller 10 can also provides a prompt message (e.g. via SMS) to the mobile telephone number associated with the person paying for parking when ten minutes of parking time is left, to alert the user that the they can pay for additional parking. For example, if the user chose to pay for only part of the time available in the parking bay, the user can elect to extend the parking time up to the maximum parking time allowed within the bay by again connecting to the controller 10. The parking controller 10 then accounts for the parking time by charging the user in accordance with the mechanism established during the user registration process.

The system according to this embodiment of the invention therefore makes it easy for an enforcement officer to determine which vehicles are illegally parked and for issuance of tickets to those vehicles. The validity of any issued tickets can be more reliably determined because of the data held within the parking controller 10 and therefore the system does not rely only on the enforcement officer to monitor parking time and issue tickets in the case of a violation. Furthermore, no currency based payments need be made by people wishing to pay for parking and therefore, the system does not require collection and processing of currency. In some embodiments, if the parking controller detects that the user has identified a bay where no car is parked yet a neighbouring bay is indicated as being freshly occupied by the camera, the user can be advised of the error by a message or via the web page served to the mobile device. The parking controller 10 may also make a suggestion to the user as to which bay is likely to be the correct bay. The web page can enable the user to complete initiation of the parking request via the web page by asking them to confirm the details.

In some embodiments, the system can be used to charge users in different ways, for example for smaller periods of time. In some embodiments, the system also advantageously removes the need for parking equipment such as boom gates and pay kiosks.

In an alternative embodiment, the parking request is initiated by a dedicated device mounted within the vehicle. In one embodiment, the device takes the form of an electronic RFID tag which has a user id linked to the vehicle and is arranged to broadcast the user id and the license plate number in response to a specific impinging radio frequency (RF) signal. In this respect, each of the parking units is arranged to incorporate a radio transceiver unit. In one embodiment, upon the sensor determining that a vehicle has entered the bay, the transceiver transmits the interrogating RF signal, receives the response where after the parking apparatus 20 forwards it as a parking request to the parking controller. In one embodiment, the sensor is a camera and also forwards an image for license plate recognition and correlation as described above. In another embodiment, a separate sensor is used to determine that the vehicle has entered the car parking bay. In another embodiment, the vehicle may have an onboard computer incorporating a processor unit which exercises control over a transceiver, such as a Bluetooth communication unit, so as to communicate with the parking apparatus. The onboard computer can store and identifier in a memory. Assuming that the driver/owner of the vehicle has pre-registered as described above, whenever the vehicle owner parks their car, its embedded identifier will be transmitted to the parking apparatus situated above the car park bay.

In yet another embodiment, the sensor is a camera and acquires an image of the driver as the driver and forwards an image for facial recognition in an analogous manner to that described with respect of license plate recognition above. Such a technique is particularly suited to private car parks for employees or other registered people as it allows the car park operator to validate that the person parking the car is entitled to park in the location. If the driver's face does not match the database, a security alert can be issued by the system to an operator of the system or other appropriate person.

Once the vehicle has been identified, the charges commence and an overhead bay display via the tablet will be activated to green. The owner's identifier is linked to their credit card so that it will be charged for the duration of their stay and when the vehicle leaves the car parking bay an SMS text message will be sent displaying the fee paid.

It will be appreciated that the above embodiments could be supplied in kit form to enable installation of a parking system.

Since modifications within the spirit and scope of the invention may readily be effected by persons skilled within the art, it is to be understood that this invention is not limited to the particular embodiment described by way of example hereinabove. In particular, features of embodiments may be combined to form further embodiments.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

1. A parking system comprising:
a plurality of parking apparatuses associated with respective ones of a plurality of parking bays, each parking apparatus comprising:
an electronic display, and
a sensor having a sensor output indicative of whether a vehicle is parked in the parking bay; and
a parking controller in data communication with each sensor and each display, the parking controller arranged to:
receive a parking request that enables the parking controller to identify a parking bay;
process the parking request to determine whether to initiate a parking session in respect of the parking bay; and
control the display associated with the parking bay to indicate that a parking session has been initiated upon initiation of a parking session.

2. A parking system as claimed in claim 1, wherein the parking controller is arranged to receive the parking request from a mobile device over a telecommunications network.

3. A parking system as claimed in claim 1, wherein the parking controller is arranged to receive the parking request from a device carried by the vehicle.

4. A parking system as claimed in claim 1, wherein the parking controller is further arranged to communicate the initiation of the parking session to a mobile device of a user of associated with the vehicle when a parking session is initiated.

5. A parking system as claimed in claim 1, wherein the parking controller is further arranged to charge a fee for the parking session to a user account.

6. A parking system as claimed in claim 5, wherein the parking controller is arranged to determine the length of stay in the parking bay based on the sensor output and determine a fee amount from the length of stay.

7. A parking system as claimed in claim 1, wherein the parking controller is arranged to process the parking request in conjunction with the sensor output for the parking bay and determine whether to initiate a parking session by determining whether the parking request correlates to the sensor output.

8. A parking system as claimed in claim 7, wherein the parking request comprises a bay identifier displayed at the parking bay and the parking controller determines whether the bay identifier correlates to the sensor output.

9. A parking system as claimed in claim 1, wherein the sensor comprises an image capture device for capturing an image of the vehicle.

10. A parking system as claimed in claim 1, wherein each parking apparatus further comprises an image capture device for capturing an image of the vehicle.

11. A parking system as claimed in claim 9, comprising a license plate recognition controller arranged to process the capture imaged to determine a captured license plate number of the vehicle.

12. A parking system as claimed in claim 11, wherein the parking request enables the parking controller to identify a license plate associated with the request and the parking controller is arranged to determine whether to initiate a parking session by determining whether the license plate associated with the parking request correlates to the captured license plate number.

13. A parking system as claimed in claim 1, further comprising a user registration system adapted to enable a user to register with the parking system and establish a user account in the parking system to enable the user to be identified and charged, and wherein the parking controller is arranged to determine whether the user is registered in the parking system prior to initiating a parking session.

14. A parking system as claimed in claim 1, wherein the parking controller is arranged to communicate an expiry warning to a mobile device of a user associated with the vehicle prior to expiry of the parking session.

15. A parking system as claimed in claim 1, wherein the parking controller is arranged to communicate enforcement data to a mobile device of an enforcement officer to enable enforcement of parking conditions in respect of terminated parking sessions.

16. A parking system as claimed claim 1, wherein the electronic display is arranged to display data specific to the user or the vehicle.

17. A parking system as claimed in claim 16, wherein the electronic display is arranged to display a license plate number corresponding to the parking session.

18. A parking system as claimed in claim 1, wherein the electronic display is arranged to indicate whether a valid parking session is in progress.

19. A parking system as claimed in claim 1, wherein each parking apparatus comprises a radio frequency module to enable the parking apparatus to communicate with the parking controller over an at least partially wireless communication link.

20. A parking system as claimed in claim 4, wherein communication of the initiation of the parking session to a mobile device includes communication of a coupon redeemable by the user for a discounted or complementary good or service.

21. A parking system kit comprising:
a plurality of parking apparatuses adapted to be associated with respective ones of a plurality of parking bays, each parking apparatus comprising:
an electronic display, and
a sensor having a sensor output indicative of whether a vehicle is parked in the parking bay; and
a parking controller adapted to be placed in data communication with each sensor and each display, the parking controller arranged to:
receive a parking request that enables the parking controller to identify a parking bay;
process the parking request to determine whether to initiate a parking session in respect of the parking bay; and
control the display associated with the parking bay to indicate that a parking session has been initiated upon initiation of a parking session.

22. A method of parking comprising:
receiving an electronic parking request that identifies a parking bay;
processing the parking request to determine whether to initiate a parking session in respect of the parking bay; and
controlling an electronic display associated with the parking bay to indicate that a parking session has been initiated upon initiation of a parking session.

23. A parking controller arranged to:
receive an electronic parking request that identifies a parking bay;
process the parking request to determine whether to initiate a parking session in respect of the parking bay; and
control an electronic display associated with the parking bay to indicate that a parking session has been initiated upon initiation of a parking session.

24. A parking apparatus adapted to be associated with a parking bay, the parking apparatus comprising:
an electronic display; and
a sensor having a sensor output indicative of whether a vehicle is parked in the parking bay,
the parking apparatus arranged to communicate with a parking controller to indicate that a vehicle has entered the parking bay, receive a communication from the parking controller indicating that a parking session has been initiated and control the display to indicate that the parking session has been initiated.
